(19) United States
(12) Patent Application Publication
(10) Pub. No.: US 2014/0319314 A1
(43) Pub. Date: Oct. 30, 2014

(54) BASE OF VENDING MACHINE

(71) Applicant: HONG FU JIN PRECISION INDUSTRY (WuHan) CO., LTD., Wuhan (CN)

(72) Inventors: TING-TING HE, Wuhan (CN); ZHI-PING WU, Wuhan (CN); CHAO LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/082,364

(22) Filed: Nov. 18, 2013

(30) Foreign Application Priority Data
Apr. 25, 2013 (CN) 2013101472556

(51) Int. Cl. G07F 9/00

(52) U.S. Cl. CPC G07F 9/00
USPC 248/678

(57) ABSTRACT

A base of a vending machine for holding a main body of the vending machine includes first holding poles, second holding poles perpendicularly connected to the first holding poles, and installation members secured in right corners between the first holding poles and the second holdings poles. The installation member includes an elastic installation portion and sidewalls. The second holding pole defines an installation hole, and the elastic installation portion is received in the installation hole. The sidewalls connect the first holding poles to the second holding poles to prevent the right corners from deforming.

### BACKGROUND

1. Technical Field

The present disclosure relates to vending machines, and particularly to a base of a vending machine.

2. Description of Related Art

A steady base is important for stability of vending machines. In use, the base is horizontally placed to hold a main body of a vending machine. Generally, the base is a rectangular frame and includes four holding poles. A steel plate is welded in each corner to prevent the rectangular frame from deforming. However, the welded steel plate increases a cost of the base. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a base of a vending machine.

FIG. 2 is an enlarged view of a circled portion II of FIG. 1.

FIG. 3 is an assembled, isometric view of the base of FIG. 1.

FIG. 4 is an enlarged view of a circled portion IV of FIG. 3.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

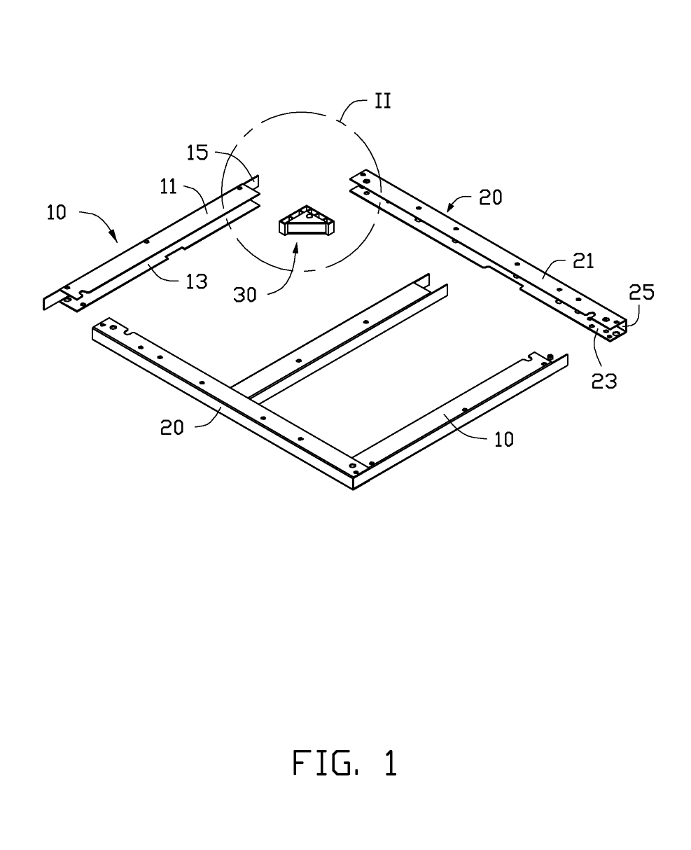

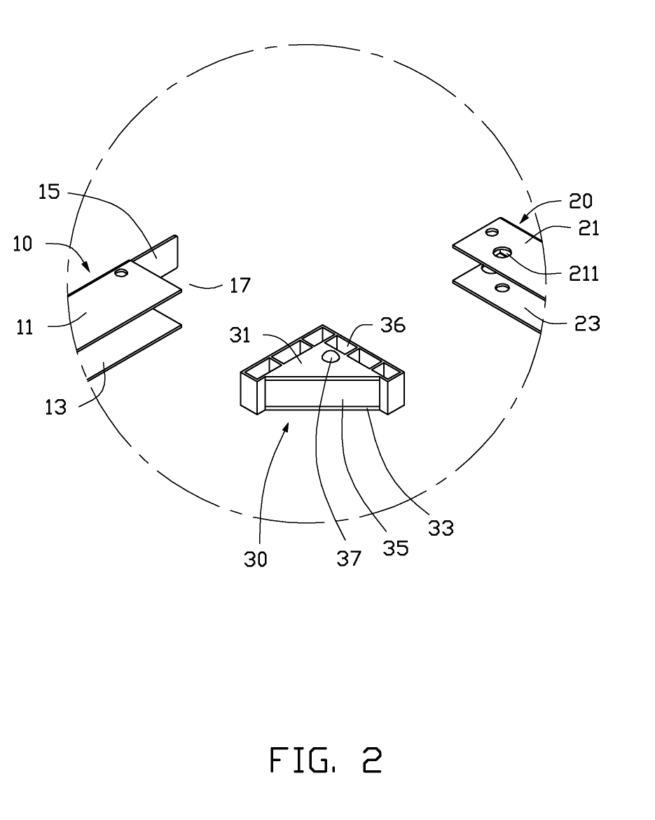

FIG. 1 and FIG. 2 show one embodiment of a base for a vending machine. The base includes two first holding poles 10, two second holding poles 20, and four installation members 30 (only one of the four installation members 30 is shown). In one embodiment, the two first holding poles 10 are substantially parallel to each other, and the two second holding poles 20 are substantially parallel to each other and are substantially perpendicular to the two first holding poles 10.

Each first holding pole 10 includes a first top plate 11, a first bottom plate 13, and a first side plate 15. In one embodiment, the first top plate 11 is substantially parallel to the first bottom plate, and the first side plate 15 is substantially perpendicular to the first top plate 11 and the first bottom plate 13. A length of the first side plate 15 is greater than a length of each of the first top plate 11 and the first bottom plate 13. Each of two opposite ends of the first side plate 15 extends past a side edge of each of the first top plate 11 and the first bottom plate 13. An installation space 17 is defined cooperatively by a portion of the first side plate 15 extended past the first top plate 11 and the first bottom plate 13, a side edge of the first top plate 11, and a side edge of the first bottom plate 13.

Each second holding pole 20 includes a second top plate 21, a second bottom plate 23, and a second side plate 25. In one embodiment, the second top plate 21 is substantially parallel to the second bottom plate 23, and the second side plate 25 is substantially perpendicular to the second top plate 21 and the second bottom plate 23. The second top plate 21 defines an installation hole 211. A distance between the second top plate 21 and the second bottom plate 23 is substantially equal to a distance between the first top plate 11 and the first bottom plate 13.

In one embodiment, a shape of each installation member 30 is substantially a right triangle. The installation member 30 includes a top wall 31, a bottom wall 33, and a sidewall 35. The top wall 31 is substantially parallel to the bottom wall 33, and the sidewall 35 is substantially perpendicular to the top wall 31 and the bottom wall 33. A plurality of through holes 36 extending through to the bottom wall 33 is defined along two side edges of the top wall 31. The through holes 36 reduce an amount of materials required to make the installation member 30 and strengthen the installation member 30. An installation portion 37 protrudes from the top wall 31. The installation portion 37 is substantially semicircular. A distance between the top wall 31 and the bottom wall 33 is substantially equal to a distance between the first top plate 11 and the first bottom plate 13. A gap (not shown) is defined between the top wall 31 and the bottom wall 33. Each installation member 30 is made of plastic.

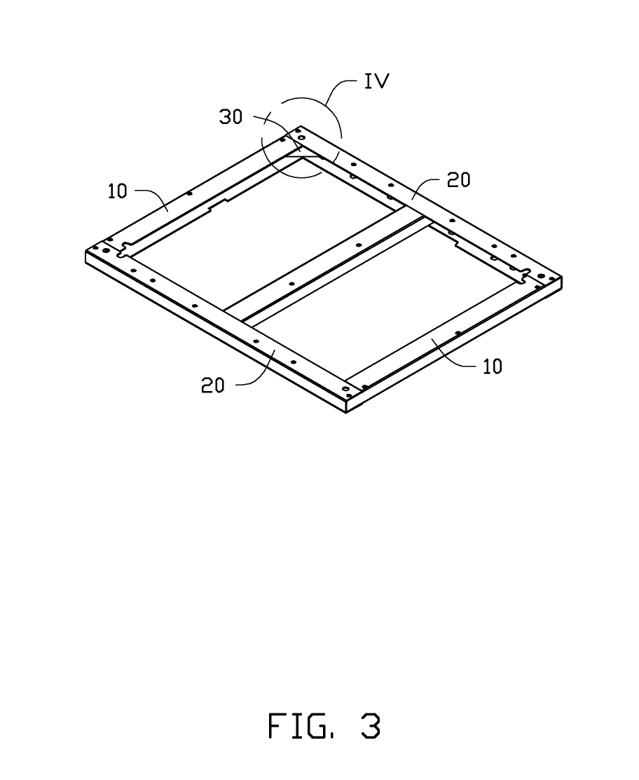

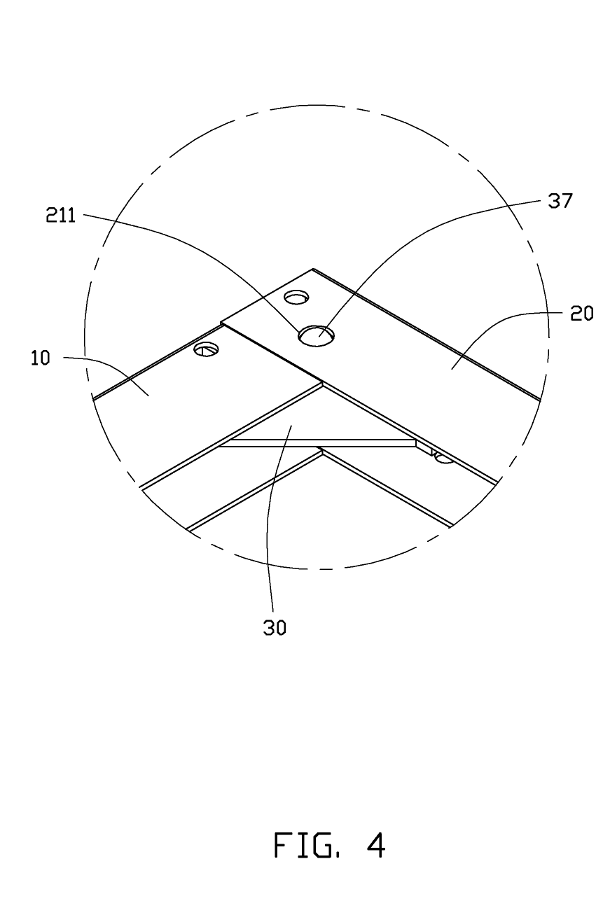

FIG. 3 and FIG. 4 show that in assembly, the two first holding poles 10 and the two second holding poles 20 are secured together end to end to form a substantially rectangular frame. Angles defined between the first holding poles 10 and the second holding poles 20 are substantially right angles. Each end of the first holding pole 10 is welded to a corresponding end of the second holding pole 20. Each installation member 30 is received in a corresponding installation space 17. As the installation member 30 is received in the installation space 17, the installation portion 37 resists the second top plate 21 to elastically deform the top wall 31 inward, until the installation portion 37 is aligned with the installation hole 211. The top wall 31 rebounds to engage the installation portion 37 in the installation hole 211. Thus, the installation member 30 is secured in the corner between the first holding pole 10 and the second holding pole 20. A first side of the installation member 30 abuts the first side plate 15, while a second side of the installation member 30 abuts the second side plate 25.

In use, the base is used for supporting a main body of the vending machine. The installation members 30 are secured in four right corners between the first holding pole 10 and the second holding pole 20, which prevents the base from deforming.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and the arrangement of parts within the principles of the disclosure, to the full extent indicated by the broad general meaning of the terms in which the appended claims are expressed.

What is claimed is:

1. A base of a vending machine for holding a main body of the vending machine, comprising:
a first holding pole;
a second holding pole perpendicularly connected to the first holding pole; and
an installation member;
wherein a corner is defined between the first holding pole and the second holding pole, and the corner is right angle; and the second holding pole is secured to the corner; the installation member comprises an elastic installation portion and a sidewall; the second holding pole defines an installation hole, and the elastic installation portion is engaged in the installation hole; and the sidewall connects the first holding pole and the second holding pole.

2. The base of claim 1, wherein the elastic installation portion is semicircular.

3. The base of claim 1, wherein the installation member further comprises a top wall and a bottom wall that is substantially parallel to the top wall, the sidewall is substantially perpendicular and connected to the top wall and the bottom wall, and the elastic installation portion protrudes from the top wall.

4. The base of claim 3, wherein the first holding pole comprises a first top plate, a first bottom plate, and a first side plate, the first top plate is substantially parallel to the first bottom plate, and the first side plate is substantially perpendicularly connected to the first top plate and the first bottom plate; a length of the first side plate is greater than a length of each of the first top plate and the first bottom plate; the first side plate extends out of the first top plate and the first bottom plate; an installation space is defined cooperatively by the portion of the first side plate, extending out of the first top plate and the first bottom plate, a side edge of the first top plate, and a side edge of the first bottom plate; and the installation space is located in the right corner.

5. The base of claim 4, wherein the second holding pole comprises a second top plate, a second bottom plate, and a second side plate, the second top plate is substantially parallel to the second bottom plate, and the second side plate is substantially perpendicularly connected to the second top plate and the second bottom plate; a first side of the installation member abuts the first side plate, and a second side of the installation plate abuts the second side plate; and the installation hole is defined in the second top plate.

6. The base of claim 5, wherein a distance between the first top plate and the first bottom plate is substantially equal to a distance between the second top plate and the second bottom plate.

7. The base of claim 6, wherein a distance between the top wall and the bottom wall is substantially equal to the distance between the first top plate and the first bottom plate.

8. The base of claim 5, wherein each of the first side and the second side of the installation member defines a plurality of through holes for decreasing a cost of the base and strengthening the base.

9. The base of claim 3, wherein each of the top wall and the bottom wall defines a right angle.

10. The base of claim 1, wherein the installation member is made of plastic.

11. A base of a vending machine for holding a main body of the vending machine, comprising:
a first holding pole;
a second holding pole perpendicularly connected to the first holding pole; and
an installation member;
wherein a corner is defined between the first holding pole and the second holding pole, and the corner is right angle; and the second holding pole is secured to the corner; the installation member comprises an elastic installation portion and a sidewall; a first side of the installation member abuts the first holding pole, a second side of the installation member abuts the second holding pole, and the first side of the installation member is substantially perpendicular to the second side of the installation member; and the sidewall connects the first side of the installation member and the second side of the installation member; and the second holding pole defines an installation hole, and the elastic installation portion is engaged in the installation hole.

12. The base of claim 11, wherein the elastic installation portion is semicircular.

13. The base of claim 11, wherein the installation member further comprises a top wall and a bottom wall that is substantially parallel to the top wall, the sidewall is substantially perpendicular and connected to the top wall and the bottom wall, and the elastic installation portion protrudes from the top wall.

14. The base of claim 13, wherein the first holding pole comprises a first top plate, a first bottom plate, and a first side plate, the first top plate is substantially parallel to the first bottom plate, and the first side plate is substantially perpendicularly connected to the first top plate and the first bottom plate; a length of the first side plate is greater than a length of each of the first top plate and the first bottom plate; the first side plate extends out of the first top plate and the first bottom plate; an installation space is defined cooperatively by the portion of the first side plate, extending out of the first top plate and the first bottom plate, a side edge of the first top plate, and a side edge of the first bottom plate; and the installation space is located in the right corner.

15. The base of claim 14, wherein the second holding pole comprises a second top plate, a second bottom plate, and a second side plate, the second top plate is substantially parallel to the second bottom plate, and the second side plate is substantially perpendicularly connected to the second top plate and the second bottom plate; the first side of the installation member abuts the first side plate, and the second side of the installation plate abuts the second side plate; and the installation hole is defined in the second top plate.

16. The base of claim 15, wherein a distance between the first top plate and the first bottom plate is substantially equal to a distance between the second top plate and the second bottom plate.

17. The base of claim 16, wherein a distance between the top wall and the bottom wall is substantially equal to the distance between the first top plate and the first bottom plate.

18. The base of claim 15, wherein each of the first side and the second side of the installation member defines a plurality of through holes for decreasing a cost of the base and strengthening the base.

19. The base of claim 13, wherein each of the top wall and the bottom wall is defines a right angle.

20. The base of claim 11, wherein the installation member is made of plastic.
